(19) United States
(12) Patent Application Publication
(10) Pub. No.: US 2001/0015215 A1
(43) Pub. Date: Aug. 23, 2001

(54) Semiconductor wafer rinse device

(76) Inventors: Patrick Massicot, Semblancay (FR); Jean-Pierre Martin, Tours (FR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/731,578

(22) Filed: Dec. 6, 2000

(30) Foreign Application Priority Data
Dec. 7, 1999 (FR) 99/15436

(51) Int. Cl. B08B 3/04

(52) U.S. Cl. 134/10; 134/26; 134/34; 134/113; 134/182; 134/902

(57) ABSTRACT

A device for rinsing batches of semiconductor wafers including a rinse vessel provided with at least one opening of overflowing water discharge, the bottom of which includes a water supply, a main outlet connected to a sewer and a recovery outlet connected to a waste water treatment plant, said at least one opening emerging into a gutter equipped with an outlet duct connected to the sewer and with a recovery duct connected to the treatment plant and said outlet duct being equipped with a controllable closing means enabling selection thereof to empty the gutter.

### TECHNICAL FIELD

The present invention generally relates to the manufacturing of integrated circuits in semiconductor wafers. More specifically, the present invention relates to a device for rinsing wafer batches.

### BACKGROUND OF TH INVENTION

Many integrated circuit manufacturing methods impose processing wafer batches in acid baths. Such processings are followed by rinse operations, which are distributed in two categories: “quick dump” rinses and “ultra-pure” rinses. Ultra-pure rinses are always preceded by a quick dump rinse.

FIG. 1 schematically illustrates a conventional quick dump rinse device 1. Device 1 includes a rinse vessel 2. The bottom of vessel 2 is equipped with a water supply 3 and two outlets 4 and 5. Supply 3 is connected to an ultra-pure water (UPW) tank 6. Outlet 4 is connected to an acid drain (AD) 7. The effluents of drain 7 are, after acid-basic neutralization, rejected into an urban sewer (not shown). Outlet 5 is connected to a wastewater treatment plant (WWTP) 8. Supply 3 and outlets 4 and 5 are equipped with controllable valves. Tank 6 is equipped with means enabling choosing the flow rate of supply 3 between two different flow levels, designated hereafter as being low or high. The vertical walls of vessel 2 include at least one opening 9 enabling discharge of overflowing waters OW to drain 7. The operation of device 1 is the following.

When brought into service, outlets 4 and 5 are closed, and supply 3 is opened to enable filling of vessel 2 at low flow rate. Once the level of openings 9 is reached, overflowing waters OW flow to drain 7.

Such a situation of waiting with a low flow rate is maintained until arrival of a batch of wafers from the acid bath preceding device 1. Then, supply 3 is closed and outlet 4 is opened.

Outlet 4 is closed once vessel 2 has been emptied. Supply 3 is then opened to enable high flow inlet of ultra-pure water from tank 6. The value of this high flow and the volume of vessel 2 being known, supply 3 is maintained open until filling of vessel 2. The possible overflowing waters OW are discharged as previously through openings 9 to drain 7. Once vessel 2 has been filled up, it is emptied again.

This filling-discharge operation, or cycle, is repeated several times. The acidity of the bath in which the batch has been previously processed and the number of wafers forming this batch being known, a number of cycles has been predetermined after which the acidity of the discharge effluents of vessel 2 is sufficiently small to enable their undergoing recycling operations in plant 8. Accordingly, after a predetermined number of cycles, typically from one to two, the discharge is no longer performed through outlet 4 to drain 7, but through outlet 5 to plant 8.

Once the batch has been rinsed, typically after five cycles, it is taken out from the rinse bath, vessel 2 being full. The previously described operations are then resumed from the waiting cycle (low flow rate, overflow through openings 9 into drain 7).

Before certain manufacturing steps, an ultra-pure rinse is sometimes required. Such a rinse is generally preceded by a quick dump rinse. An ultra-pure rinse device (not shown) is similar to a quick dump rinse device such as previously-described device 1, but further includes a means for determining the degree of acidity of the discharge effluents. Such a means is generally a resistivity probe. Indeed, ultra-pure water has a resistivity on the order of 18 MΩ, while an acid water sees its resistivity fall to zero. The filling cycle at high flow rate is then carried out until a satisfactory level of acidity generally corresponding to a resistivity from 7 to 8 MΩ is reached.

A disadvantage of these two types of rinses is the large amount of water consumed, that is, the amount of water discharged to a urban sewer via an acid drain.

### SUMMARY OF THE INVENTION

An object of the present invention is to provide a novel type of rinse device enabling a reduced water consumption.

Another object of the present invention is to provide such a device that may be used for quick dump rinses as well as for ultra-pure rinses.

To achieve these objects, an embodiment of the present invention provides a device for rinsing batches of semiconductor wafers including a rinse vessel provided with at least one opening of overflowing water discharge, the bottom of which includes a water supply, a main outlet connected to a sewer and a recovery outlet connected to a waste water treatment plant, said at least one opening emerging into a gutter equipped with an outlet duct connected to the sewer and with a recovery duct connected to the treatment plant, said outlet duct being equipped with a controllable closing means enabling selection thereof to drain the gutter.

According to an embodiment of the present invention, the recovery duct is of overflow type.

According to an embodiment of the present invention, a siphon, the bottom of which includes a means for measuring the effluent acidity, is inserted in the recovery duct before the treatment plant.

According to an embodiment of the present invention, the means for measuring the acidity is a probe for measuring the water resistivity.

According to an embodiment of the present invention, the water supply is connected to an ultra-pure water tank.

According to an embodiment of the present invention, the water supply is equipped with means adapted to selecting the flow rate from two different levels.

According to an embodiment of the present invention, the controllable closing means of the outlet duct is a valve.

An embodiment of the present invention also provides a method for rinsing semiconductive wafer batches including the steps of:

a) filling a rinse vessel with ultra-pure water supplied by a tank via a water supply;

b) opening an outlet duct located at the bottom of a gutter on which emerges at least one overflowing water flow opening, said at least one opening being located in at least one wall of the vessel, said duct being connected to an acid drain;

c) inserting a batch of wafers in the vessel;

d) opening the main outlet, then performing a predetermined number of successive vessel filling-discharge cycles; and

e) taking out the batch of rinsed wafers and resuming step a), after a given number of cycles of step d), the following cycles being performed as the outlet duct of the gutter is closed, the flow of overflowing waters collected in the gutter occurring through a recovery duct connected to a waste water treatment plant, the successive vessel discharges being then performed via a recovery outlet connected to said plant.

According to another embodiment of the present invention, the recovery duct of the gutter includes a means for determining the effluent acidity, step e) consisting of taking the wafer batch out being replaced by the following step sequence:

e1) closing the recovery outlet of the vessel, opening the water supply to enable the filling of the vessel with a high flow rate and maintaining the recovery duct open; and

e2) taking out the wafer batch when the acidity of the effluents in the recovery duct has dropped to a predetermined sufficiently low level; and

e3) resuming the preceding steps from step a).

According to an embodiment of the present invention, the means for determining the effluent acidity is a resistivity probe placed at the bottom of a siphon inserted in the recovery duct before the treatment plant, step e3) of taking out the wafer batch from the vessel being performed when the effluent resistivity becomes greater than a value between 7 and 8 MΩ.

### BRIEF DESCRIPTION OF THE DRAWINGS

The foregoing objects, features and advantages of the present invention will be discussed in detail in the following non-limiting description of specific embodiments in connection with the accompanying drawings.

FIG. 1 schematically illustrates a conventional semiconductor wafer rinse device; and

FIG. 2 schematically illustrates a semiconductor wafer rinse device according to an embodiment of the present invention.

FIG. 3 schematically illustrates a portion of a semiconductor wafer rinse device according to another embodiment of the present invention.

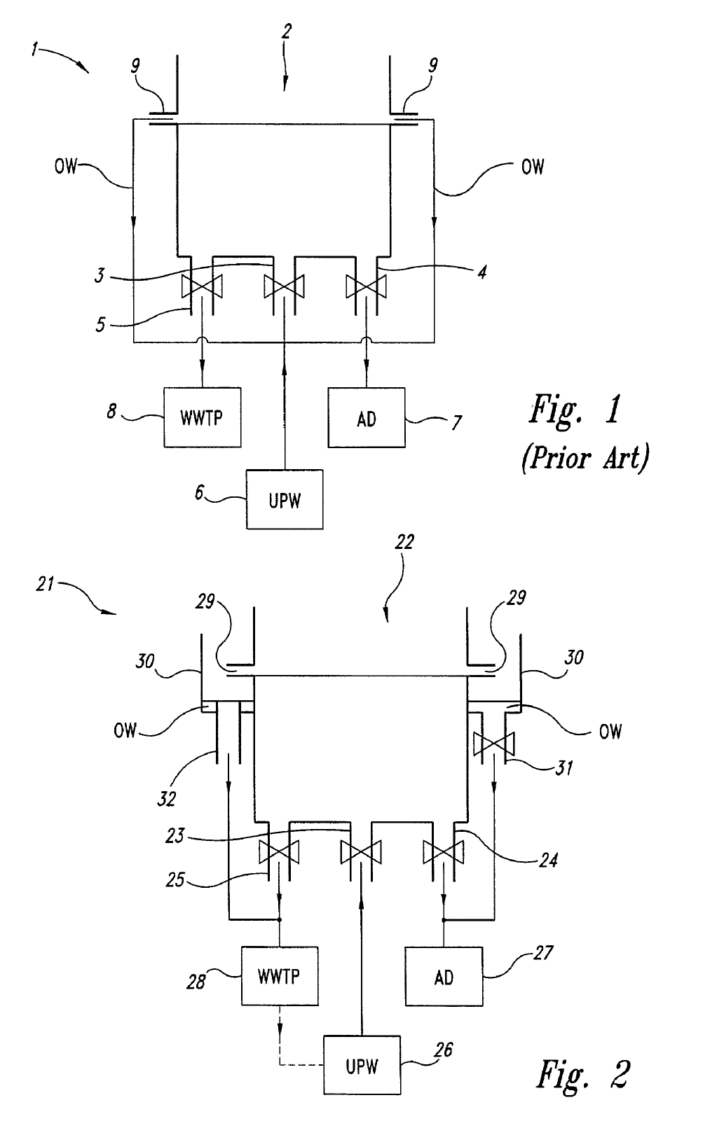

### DETAILED DESCRIPTION OF THE ILLUSTRATED EMBODIMENT

According to a first embodiment of the present invention, schematically illustrated in FIG. 2, a device 21 for rinsing integrated device wafer batches includes a rinse vessel 22 adapted for receiving the batches coming out from an acid bath (not shown). The bottom of vessel 22 includes a water supply 23 connected to an ultra-pure water (UPW) vessel 26. The bottom of vessel 22 also includes a main outlet 24 and a recovery outlet 25 respectively connected to an acid drain (AD) 27 and to a waste water treatment plant (WWTP) 28. The effluents of drain 27 are, after an acid-basic neutralization, rejected into an urban sewer (not shown). The connection between vessel 26 and supply 23 is equipped with a means adapted to choosing the flow rate from two different flow rate levels, which will be called hereafter the low and the high flow rates. At least one of the vertical walls of vessel 22 includes at least one opening 29 enabling discharge of overflowing waters (OW). Openings 29 emerge into a gutter 30, the bottom of which includes an outlet duct 31 and a recovery duct 32. Outlet duct 31 is connected to drain 27 while recovery duct 32 is connected to plant 28.

As illustrated in FIG. 2, recovery duct 32 is of “overflow” type, and exhibits as such an opening at a raised level with respect to the bottom of gutter 30. Of course, the opening of recovery duct 32 is under the upper level defined by the walls of gutter 30.

The bottom of gutter 30 is inclined to further the flow of overflowing waters OW and the discharge of gutter 30 through duct 31. Water supply 23 and outlets and ducts 24, 25, and 31 are each equipped with a controllable valve.

The operation of device 21 is the following.

As the device is put into service—or during a waiting situation—the valves in outlets 24 and 25 are closed, as well as in duct 31. The valve in supply 23 is open, to fill up vessel 22 with a low ultra-pure water flow. Once vessel 22 has been filled up, overflowing waters OW flow via duct 32 to plant 28, wherefrom they can be injected back into the circuit, as indicated by the arrow in dotted lines.

Upon arrival of a batch of wafers into the acid bath preceding device 21, the previously described waiting situation ends. The valve in supply 23 is closed and the valve in duct 31 is opened. Providing the discharge of gutter 30 through duct 31 before arrival of the batch into rinse vessel 22 and using a recovery duct 32 of overflow type advantageously enables avoiding contamination of treatment plant 28 by an inflow of overflowing waters OW made very acidic by the arrival of the batch.

Once the batch has been placed in vessel 22, the vessel is emptied through outlet 24. Once vessel 22 is empty, the valve in outlet 24 is closed. The valve in supply 23 is then opened to enable inlet at a high flow rate of ultra-pure water. The valve in supply 23 is maintained open for a sufficiently long time to fill up vessel 22. Possible overflowing waters OW are discharged through openings 29 to drain 27 via gutter 30 and duct 31.

After a given predetermined number of cycles, typically from one to two, vessel 22 is emptied, no longer into an urban sewer via outlet 24 and drain 27, but into plant 28 via recovery outlet 25. Similarly, after the same number of cycles, the outlet of gutter 30 switches from outlet duct 31 to recovery duct 32. It should be noted that during a filling of vessel 22, the valve in duct 31 may be maintained open or closed, according to the cycle previously performed and/or to come.

Once the batch has been rinsed, for example after five cycles, it is taken out of vessel 22, which is full. Device 21 is then set back to a waiting situation.

An advantage of the present invention is to considerably reduce water consumption. Indeed, to avoid any possible contamination, a rinse device such as device 21 is maintained for a relatively long time in waiting situations. The recovery of overflowing waters OW, in waiting situations and appropriate rinse cycles, via duct 32 and their treatment by plant 28 enables increasing by 50% the amount of treated water. It should however be noted that, as appears from the foregoing description, overflowing waters OW that are too acidic to be treated are advantageously discharged into an urban sewer.

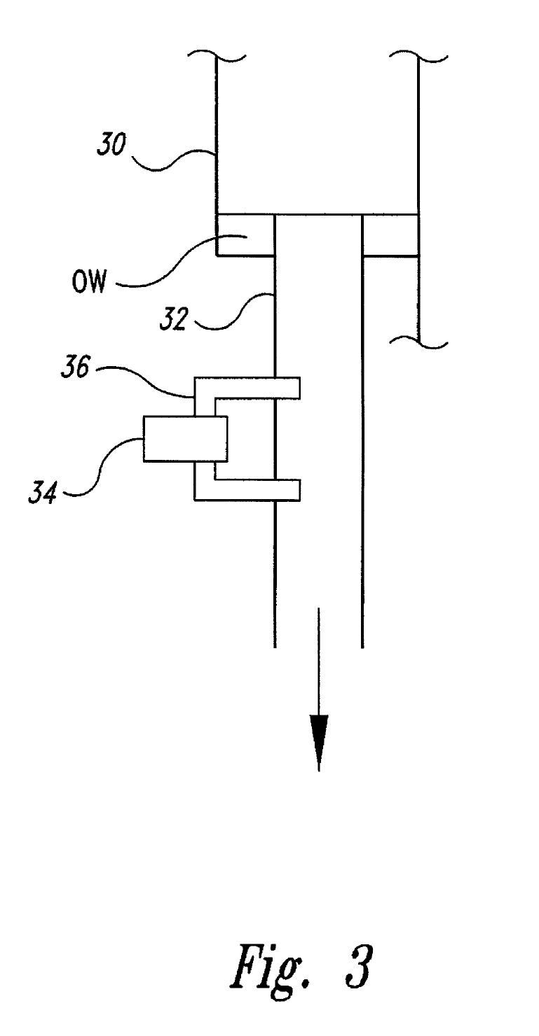

According to another embodiment, shown in part in FIG. 3, duct 32 for recovering overflowing waters OW to be directed to waste water treatment plant 28 is equipped with a means for measuring the effluent acidity level. According to a specific embodiment, such a means will be a resistivity probe 34 placed at the bottom of a siphon 36 located in duct 32 upstream of plant 28. The presence of such a probe 34 enables using, if necessary, at the end of the quick dump rinse, the same vessel 22 as an ultra-pure rinse vessel.

Indeed, at the end of the quick dump rinse, for example after five cycles, the effluents have a sufficiently low acidity to be able to be treated by plant 28. However, the wafer acidity level may still be too high for some subsequent processings. Then, at the end of the fifth cycle, the water supply at a high flow rate is maintained, and overflowing waters OW are discharged through duct 32 to plant 28 via the siphon 36, in which the probe 34 measures the effluent resistivity. The ultra-pure water supply is then maintained until the effluent resistivity reaches a satisfactory level, for example between 7 and 8 MΩ.

An advantage of this other embodiment is to spare the volume of a vessel. Indeed, the same tank is then used as a quick dump rinse vessel and as an ultra-pure rinse vessel. Then, the water consumption due to decontamination operations as the device is started and in waiting situations is divided by two as compared to a conventional method using two vessels.

Another advantage of this other embodiment is that the “ultra-pure” rinse waters are all recovered to be treated.

According to an alternative embodiment, the rinse vessel may be equipped with devices of shower hose type. Such devices are placed in the upper portion of the vessel. Their openings are arranged and directed downwards so that a wafer batch placed at the bottom of the vessel is showered. The devices are supplied in the presence of a batch, during all vessel discharge and filling steps. In the absence of any batch, that is, as the device is put into service and/or during low flow rate continuous supply waiting situations, the devices are not used.

Of course, the present invention is likely to have various alterations, modifications, and improvements which will readily occur to those skilled in the art. In particular, the means for determining the water acidity degree may be other than a resistivity probe. Further, those skilled in the art will know how to adapt the flow rates, the dimensions of the vessel, of the gutter and of the various outlets and ducts as well as the controls of the different valves to a specific manufacturing process.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A device for rinsing batches of semiconductor wafers, comprising a rinse vessel provided with at least one opening of overflowing water discharge, a bottom of the rinse vessel includes a water supply, a main outlet connected to a sewer and a recovery outlet connected to a waste water treatment plant, wherein said at least one opening emerges into a gutter equipped with an outlet duct connected to the sewer and with a recovery duct connected to the treatment plant, said outlet duct being equipped with a controllable closing means enabling selection thereof to drain the gutter.

2. The device of claim 1, wherein the recovery duct is of overflow type.

3. The device of claim 1, wherein a siphon, the bottom of which includes a means for measuring the effluent acidity, is inserted in the recovery duct before the treatment plant.

4. The device of claim 3, wherein the means for measuring the acidity is a probe for measuring the water resistivity.

5. The device of claim 1, wherein the water supply is connected to an ultra-pure water tank.

6. The device of claim 5, wherein the water supply is equipped with means adapted to selecting the flow rate from two different levels.

7. The device of claim 1, wherein the controllable closing means of the outlet duct is a valve.

8. A method for rinsing semiconductive wafer batches comprising the steps of:
a) filling a rinse vessel with ultra-pure water supplied by a tank via a water supply;
b) opening an outlet duct located at the bottom of a gutter on which emerges at least one overflowing water flow opening, said at least one opening being located in at least one wall of the vessel, said duct being connected to an acid drain;
c) inserting a batch of wafers in the vessel;
d) opening the main outlet, then performing a predetermined number of successive vessel filling-discharge cycles; and
e) taking the batch of rinsed wafers out of the vessel, and resuming at step a), and wherein after a given number of cycles of step d), the following cycles are performed as the outlet duct of the gutter is closed, the flow of overflowing waters collected in the gutter occurring through a recovery duct connected to a waste water treatment plant, the successive vessel discharges being then performed via a recovery outlet connected to said plant.

9. The method of claim 8, wherein the recovery duct of the gutter includes a means for determining the effluent acidity, step e) consisting of taking the wafer batch out being replaced by the following step sequence:
e1) closing the recovery outlet of the vessel, opening the water supply to enable the filling of the vessel with a high flow rate and maintaining the recovery duct open; and
e2) taking the wafer batch out of the vessel when the acidity of the effluents in the recovery duct has dropped to a predetermined sufficiently low level; and
e3) resuming the preceding steps from step a).

10. The method of claim 8, wherein the means for determining the effluent acidity is a resistivity probe placed at the bottom of a siphon inserted in the recovery duct before the treatment plant, and wherein step e3) of taking the wafer batch out of the vessel is performed when the effluent resistivity becomes greater than a value between 7 and 8 MΩ.

11. A system for rinsing semiconductor wafers, the system comprising:
a vessel configured to retain a fluid within the vessel at least up to an overflow level;
a water supply line configured to deliver a water supply to the vessel;
an opening in the vessel near the overflow level for maintaining the fluid level in the vessel at or below the overflow level;
a first outlet coupled to the vessel and configured to selectively direct the fluid from the vessel to a sewer;
a second outlet coupled to the vessel and configured to selectively direct the fluid from the vessel to a waste water treatment plant;
a first duct in fluid communication with the opening in the vessel, the first duct configured to direct the fluid from the vessel to the sewer;
a second duct in fluid communication with the opening in the vessel, the second duct configured to direct the fluid from the vessel to the waste water treatment plant; and
a controllable closure in the first duct to selectively direct the fluid from the opening in the vessel to the sewer.

12. The system of claim 11, further comprising a gutter located to receive the fluid as it exits the opening in the vessel, and wherein the first and second ducts are coupled to the gutter.

13. The system of claim 11, further comprising a gutter located to receive the fluid as the fluid exits the opening in the vessel, and wherein the first and second ducts are coupled to the gutter, the first duct having a first mouth for receiving the fluid and the second duct having a second mouth for receiving the fluid, the second mouth being located horizontally higher than the first mouth such that, when the controllable closure in the first duct is open and a level of the fluid is horizontally below the second mouth, the fluid exiting the opening in the vessel enters only the first mouth and is directed to the sewer, but when the controllable closure in the first duct is closed, the fluid exiting the opening in the vessel enters only the second duct and is directed to the waste water treatment plant.

14. The system of claim 11 wherein the controllable closure is a valve.

15. The system of claim 11, further comprising a means for measuring an acidity of the fluid.

16. The system of claim 11, further comprising a means for measuring an acidity of the fluid as the fluid flows through the second duct.

17. The system of claim 11, further comprising a probe for measuring a resistivity of the fluid such that the user can determine an acidity of the fluid.
